(19) United States
(12) Patent Application Publication
(10) Pub. No.: US 2015/0045106 A1
(43) Pub. Date: Feb. 12, 2015

(54) SELECTABLE BONUS GAME GAMING MACHINE AND METHOD

(71) Applicant: Qin You, Randwick (AU)

(72) Inventor: Qin You, Randwick (AU)

(73) Assignee: Bally Technologies ANZ Pty Ltd, Milperra (AU)

(21) Appl. No.: 14/456,291

(22) Filed: Aug. 11, 2014

(30) Foreign Application Priority Data
Aug. 12, 2013 (AU) 2013216580

(51) Int. Cl. G07F 17/34; G07F 17/32

(52) U.S. Cl. CPC G07F 17/34; G07F 17/3213
USPC 463/20

(57) ABSTRACT

A gaming machine and method of operation are disclosed, in which a primary game is played, and then a feature game may be triggered. The feature game allows the player to select a simulated reel gaming array from a within a selection of arrays, wherein at least some of the arrays have a different number of symbol positions to others in the selection.

### CROSS REFERENCE TO RELATED APPLICATION

This application claims priority to Australian Application No. 2013216580 filed Aug. 12, 2013, incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present invention relates to gaming machines, gaming software and method for operating such machines. More particularly, it relates to the operation and selection of the bonus features within such machines.

### BACKGROUND OF THE INVENTION

New gaming machines, and games, are developed in order to gain and maintain player interest. As is well known, such machines receive a wager, play a game, and selectively award prizes to players. Although the outcome of a particular game is governed by a random or pseudo random process, the overall statistical return to player is predetermined.

In one group of games, symbols are generated or moved randomly to determine the outcome of a game. An example of this is a simulated reel game, in which an array of (for example) 3 reels are caused to virtually spin, so as to settle on a 5 by 3 array of symbols. If the symbols meet predetermined rules, then a prize is awarded.

In some games, certain symbol combinations (whether in a single game or across multiple games) trigger a feature or bonus game. Such feature games may in some cases be generated by a random process, or as part of a jackpot system. For the purposes of this specification and claims, a feature game is a game where a second set of rules apply, for example where the feature game is a different game, where symbols are treated differently, where some symbols appear more or less frequently, where free spins are awarded, or any other change in the game. It may be triggered by a specific symbol combination, by a random or pseudo random process, or in any other suitable way. The feature may always result in a prize being awarded, the feature merely determining which prize, or in other forms may only award a prize to some outcomes.

Feature games provide an interesting additional component of game play, associated as they often are with a relatively large payout or jackpot for the player.

It has been disclosed in various prior art documents that once a feature game has been triggered, that the player can select from various options for the particular feature game they wish to play. For example, in US 20070060629 by Bally Gaming Inc, it is disclosed that a number of options for a feature game are presented to the player after a triggering event.

In AU776584 by Aristocrat Technologies Australia Pty Ltd, there is disclosed a game in which upon the occurrence of a predefined event, the player can select from two or more different prize sets, from which set a prize is then selected for the player.

In AU 756193 by I.G.T.(Australia) Pty Ltd, a bonus game is disclosed in which a player is presented with three rows of cards, each row having different numbers of cards, and different odds payable for selecting the correct card.

It is an object of the present invention to provide a different form of selectable feature game.

### SUMMARY OF THE INVENTION

In a broad form, the present invention provides method for operating a gaming machine, in which a feature game allows the player to select a simulated reel gaming array from a within a selection of arrays, wherein at least some of the arrays have a different number of symbol positions to others in the selection.

According to one aspect, the present invention provides a method for operating a gaming machine, including at least the steps of:
(a) Providing a first game to a player, including displaying a set of gaming symbols;
(b) Playing said first game, and if a triggering event occurs, commencing a feature game;
(c) presenting the player with a selection from a set of simulated reel game arrays, each game array in said set having a number of symbol positions, wherein at least two of said game arrays have a different number of symbol positions, and accepting a selection from said player; and
(d) playing said feature game in accordance with the selected reel game array.

According to another aspect, the present invention provides a gaming machine, including a processing unit, at least one display, and player operable controls for operatively making selections during the operation of the gaming machine, the processing unit being configured and adapted to play a primary game, including causing a set of symbols on said display, and being further adapted to determine whether a triggering event for a feature game has occurred,

Wherein if the triggering event has occurred, commencing play of a feature game, by first presenting the player with a selection from a set of simulated reel game arrays, each game array in said set having a number of potential symbol positions, wherein at least two of said game arrays have a different number of symbol positions, accepting a selection from said player; and playing said feature game in accordance with the selected reel game array.

The present invention also encompasses software products and stored software operatively adapted to carry out the method when made operative on a gaming machine or processor.

### BRIEF DESCRIPTION OF THE DRAWINGS

A illustrative embodiments of the present invention will be described with reference to the accompanying drawings, in which:

FIG. 1 illustrates a functional block diagram of an illustrative gaming machine;

FIG. 2 is a screen shot showing symbols displayed in a primary game;

FIG. 3 is a screen shot of a paytable for a primary game:

FIG. 4 is a screen shot of a explanation of the operation of the free games feature game;

FIG. 5 is a screen shot of the selection screen for the feature game;

FIG. 6 is a screen shot of the operation of a 3 by 5 array in the feature game;

FIG. 7 is a screen shot of the operation of a 4 by 5 array in the feature game;

FIG. 8 is a screen shot of the operation of a 5 by 5 array in the feature game; and

FIG. 9 is a flow chart illustrating the operation of the method according to the embodiment of FIGS. 2 to 8.

### DESCRIPTION OF THE INVENTION

The present invention will be described with reference to an implementation using a conventional gaming machine, or slot machine. It will be appreciated that the present invention may be implemented as any kind of desired game, whether for gambling purposes or as a recreational game. It may be implemented, in alternative implementations, as a computer game, for server based gaming, via an internet gaming site, as an app for smartphones or tablets, or in any other suitable way.

The general operation of the implementations to be described is that the player first operates a primary, underlying game on the gaming machine, and that only in certain circumstances does the feature games commence. The underlying game may be of any type. It need not be a simulated reel based game—it may be a card game, a selection type game, a simulated casino game, or any other suitable base game. The implementation to be described uses a simulated reel type game as the primary game.

The term triggering event, for the purpose of this specification and claims, means any event which according to the rules of the primary game, or any jackpot or multi-terminal system in which it operates, triggers the feature game. For example, this may be through an event in the primary game, for example a certain number of specific symbols in a payline, or scattered symbols, or a specific combination of symbols. The triggering event could be governed by the jackpot system, being either symbol driven, occurring at a random time or jackpot value, by a random or pseudo random process, or in any other suitable way. The present invention is not limited by any particular mode in which the triggering event operates.

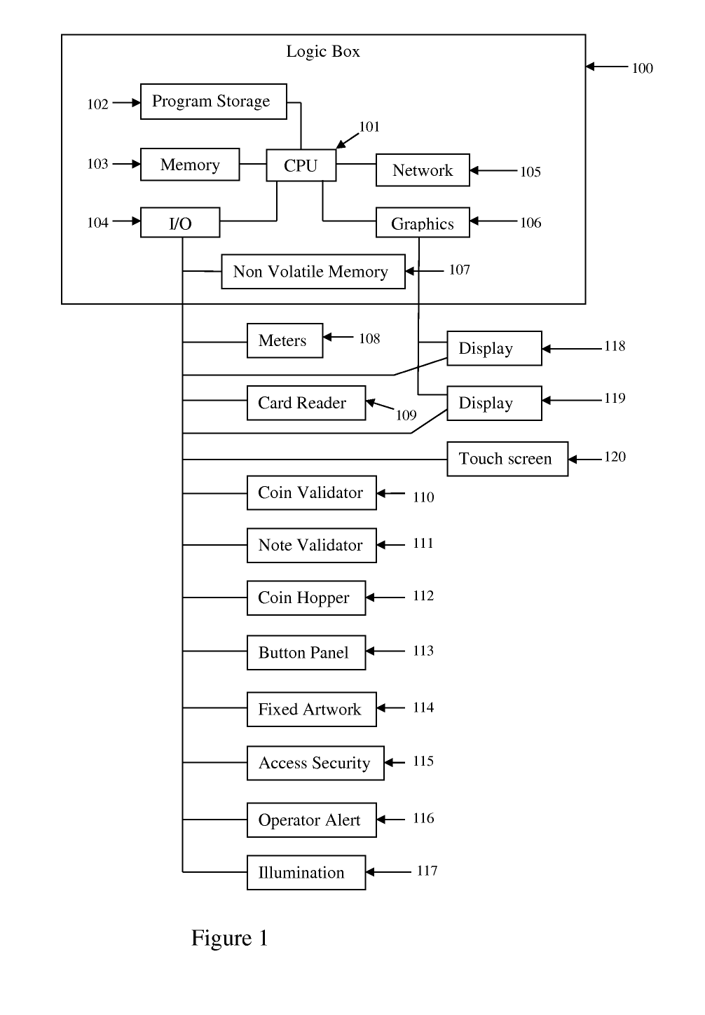

The present invention may be implemented using, for example, any kind of conventional gaming machine. FIG. 1 illustrates the components of a typical machine, which is connected to a network and thus to a central monitoring system or site controller, and potentially to other gaming machines. Appendix 1 describes the components and operations of such a typical machine. Examples of such a conventional machine are the machine available commercially from the applicant.

Following is a description of a particular implementation of the present invention. It will be understood that this is intended as illustrative and is not limitative of the scope of the invention.

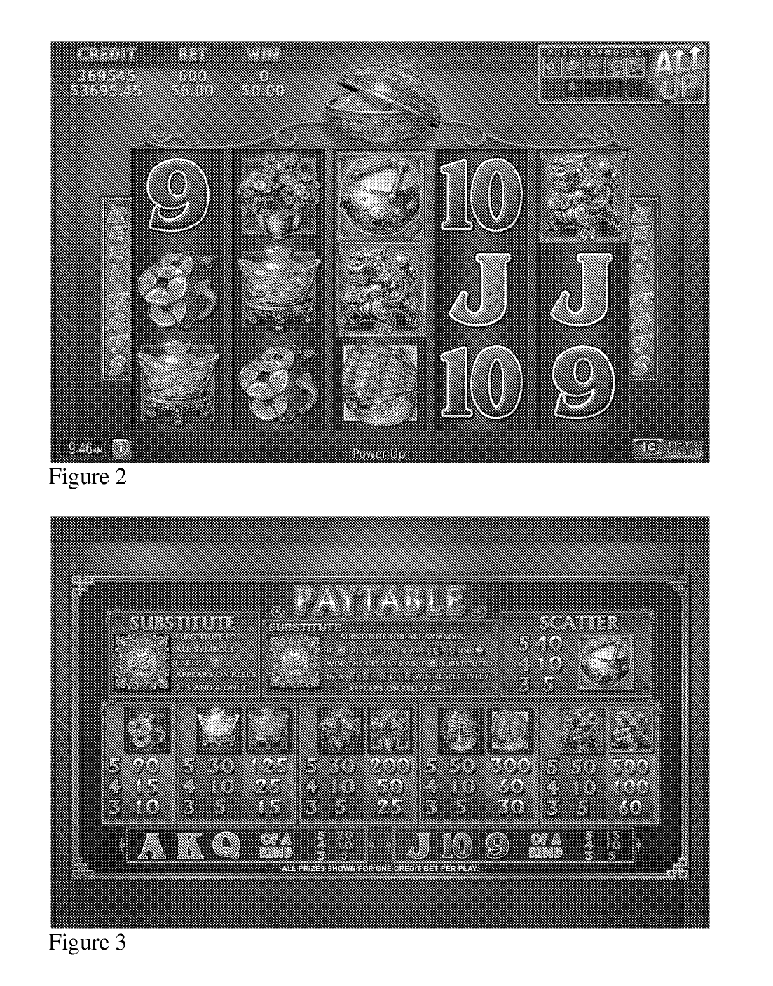

FIG. 2 illustrates an example screen shot from a primary game according to the illustrative implementation of the present invention. It can be seen that it is a 3 symbol position high, 5 reel wide simulated reel display, which will be referred to as a 3 by 5 array. The precise details of the primary game are, as previously discussed, not important to the operation of the feature game.

FIG. 3 illustrates a paytable for the game. According to the implementation, this paytable also operates during the free games produced as a consequence of the feature game being triggered, as will be discussed further below. As is explained, when certain combinations of symbol indicia, whether in a particular line in some cases or scattered in other cases, are present the corresponding payments are made.

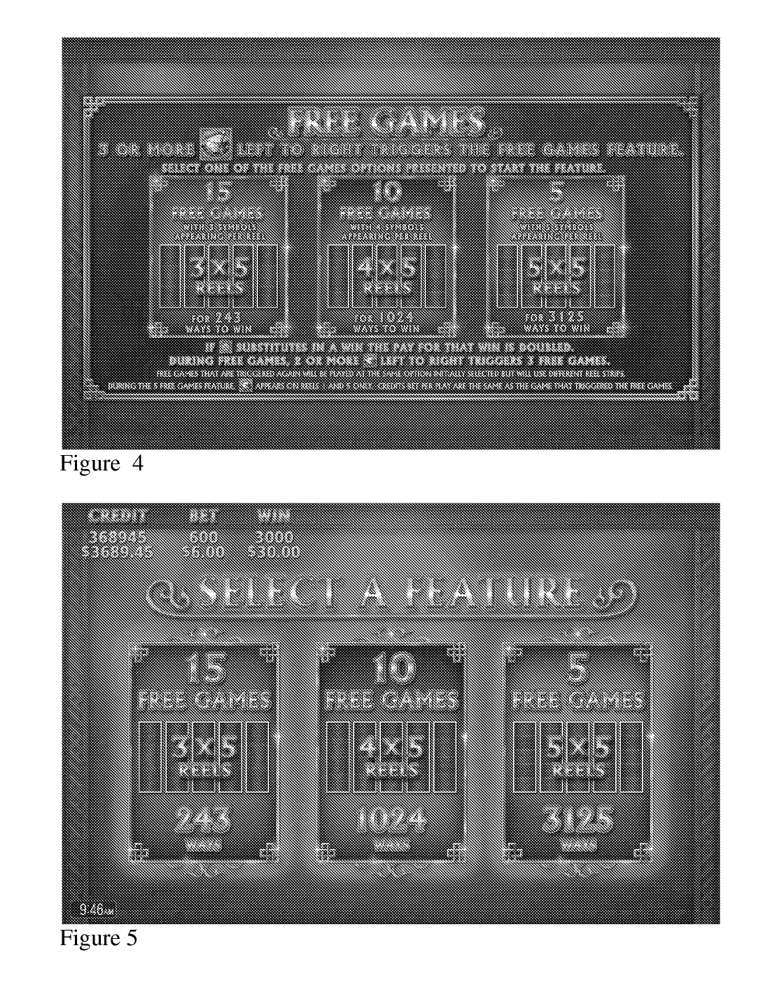

FIG. 4 is a rules screen explaining the operation of the feature game. If 3 or more drum symbols appear left to right on a payline, then the free game feature is activated. This is the feature game according to this implementation.

As can be seen from FIG. 4, the player can then choose either to play 15 free games in a 3 by 5 array, 10 free games in a 4 by 5 array, or 5 free games in a 5 by 5 array. In practical implementations, the return to player (RTP for each option) is identical, in order to conform to regulatory requirements. This particular game utilizes the REEL WAYS™ pay structure, where pays are provided for the occurrence of three or more identical symbols appearing in any position on adjacent but different reels within the array, starting from the leftmost reel (i.e., pays any left to right). Hence, there are 3125 possible 5-of-a-kind symbol combinations, or ‘ways’, in the 5 by 5 array, as opposed to 243 ways in the 3 by 5 array, and 1024 ways in the 4 by 5 array. The symbol frequency and positioning is adjusted by utilizing different sets of reel strips to equalise the RTP for each free game option, as would be well understood by those skilled in the art. Of course, the specifics of this are dependent upon the rules or the specific game in question.

Unlike payline wins, the REEL WAYS™ pay structure pays for combinations of matching symbols appearing on adjacent reels, starting from the leftmost reel, wherein at least one of the matching symbols is unique to each pay.

REEL WAYS™ differs from scatter pays in that scatter pays pay for multiple scatter symbols appearing anywhere on the display, or on specific reels on the display, in any frequency. For example:

| | |
|---|---|
| S | |
| | S |
| S | |

The above outcome would pay for 3 scatter symbols “5”, while this would not be an all-ways winning event because there are no matching symbols on 3 adjacent reels (left to right).

However, it is to be noted that payline wins may also be implemented in the invention, instead of ways wins, in which case the number of paylines provided for each game will depend on the size of the array.

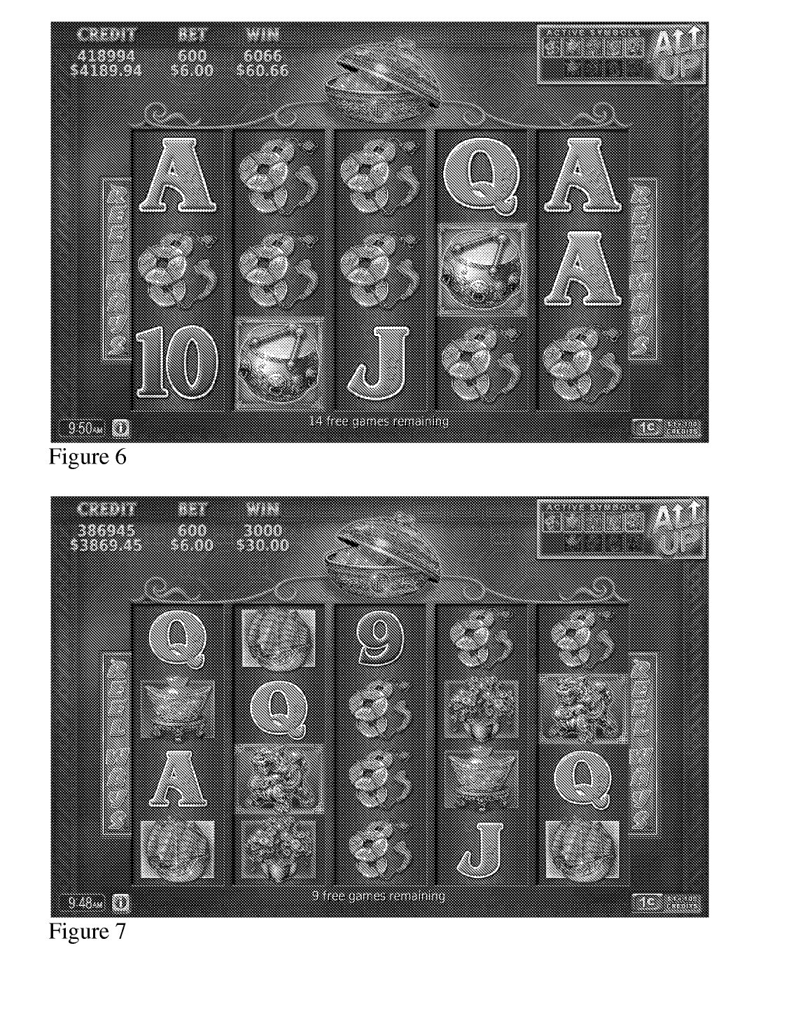

FIG. 5 shows a screen shot of the feature selection screen, shown to the player after the feature has been triggered. In a touchscreen implementation, the player simply touches the desired array option. In other implementations, a button may be pressed as indicated by a display in order to make the selection.

Once the player has made a selection, the free games automatically start by spinning the reels to a stop position. In an alternative implementation, the free games could await a selection by the player pressing a start button, or the like. However, as there are no further choices to be made by the player, it is preferred to play the free games at a predetermined pace. It will be appreciated that the value of the wager for each of the free games is preferably the same as in the primary game which led to the feature game, to ensure proportionality of wins. Hence, the player has no ability to alter the amount of the wager for the free games.

It is noted that according to this implementation, more free games can also be won during the free game feature, if two or more drum symbols appear left to right during one of the free games. This is explained in the rules screen of FIG. 4. Any such free games operate using the selected array option, but may use different reel strips.

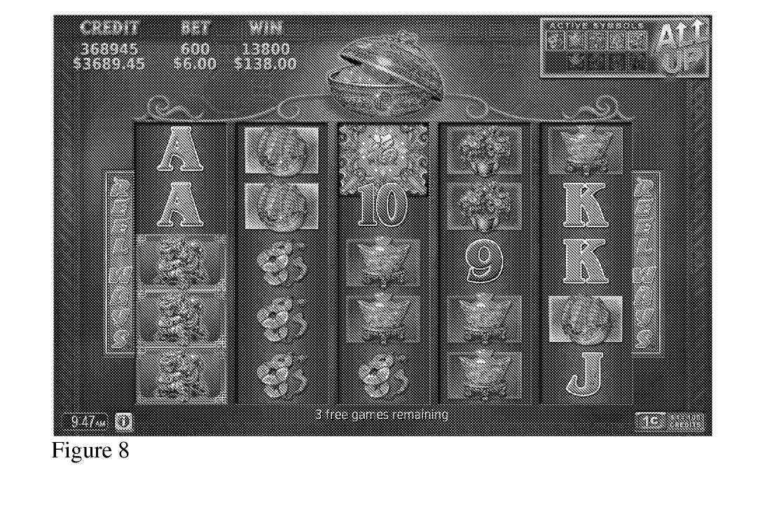

FIG. 6 shows the free game feature in operation, with the 3 by 5 array and 15 free game option. FIG. 7 shows the 4 by 5 array and 10 free game option in operation. FIG. 8 shows the 5 by 5 array and 5 free game option in operation.

It will be apparent that the number of free games available for each option is, in part, a function of not only the array chosen, but the corresponding reel strips which are utilised.

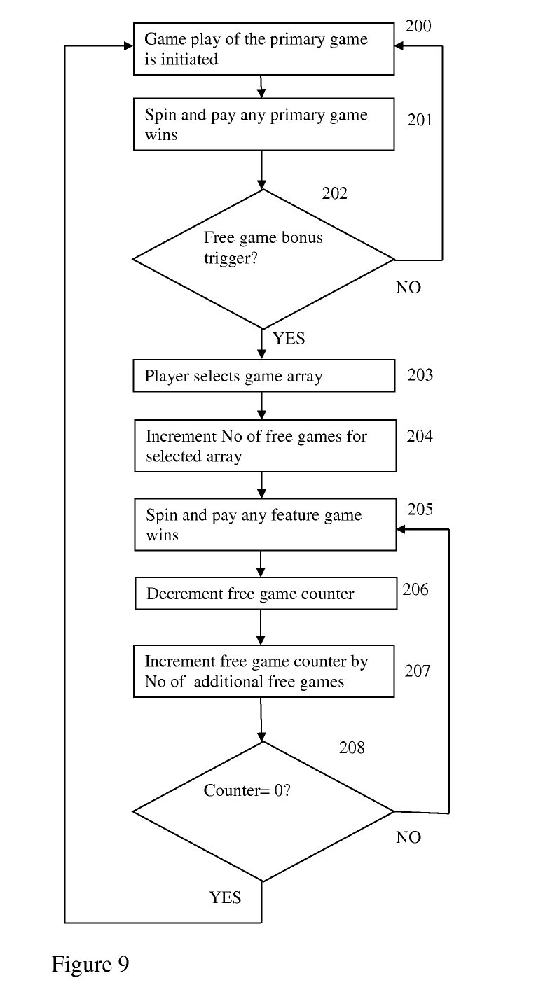

FIG. 9 is a flow chart illustrating the operation of a method as described with reference to FIGS. 2 to 8.

At 200, game play is initiated. Note, for the purposes of clarity, the process by which the player nominates a wager value, or where applicable paylines, is omitted from this method. It is assumed that credits are available and are decremented when played in the normal way.

At 201, the primary game is played, the reels are spun and a final configuration displayed. Any primary game wins are paid. At 202, the outcome is tested to determine if the free game bonus trigger has occurred. In the illustrative game, this is 3 or more drum symbols left to right. If not, the method loops back to step 200, and game play in the primary game continues as normal.

If the feature game trigger has occurred, the selection step displays the selection screen of FIG. 4, and the player selects one of the available arrays, at step 203. The free game counter is then incremented as required, depending upon the number of free games corresponding to the option (i.e. 5, 10 or 15 in this example) selected, at step 204.

The feature game then spins and pays any wins resulting from the outcome of the feature game at step 205. While the rules may be common to the base game, it will be appreciated that different sets of reel strips appropriate to produce the required RTP are used. The free spin counter is then decremented by one at 206.

As outlined above, it is possible for the player to gain further free spins based on the outcomes of the free spin games, as indicated by step 207. In that case, the free game counter is incremented as required. It will be appreciated that step 207 could occur prior to step 206.

At step 208, if the free game counter is zero, the game reverts to normal play at step 200. If not, then the free game is spun at step 205 again.

It will be appreciated that the method and gaming machine may be implemented using any suitable software technique of language, consistent with the operating system, regulatory requirements and hardware used. Those skilled in the art are readily capable of producing appropriate code to implement the examples shown herein.

The term processor is used to refer to any suitable microprocessor, or other electronic device or combination of devices adapted to carry out processes in accordance with an appropriate software instruction set.

As noted, the present invention may be used in conjunction with any suitable primary game, for example games currently available in the market with alternative feature games. The present invention may be implemented with any suitable additions, alternatives and variations. For example, more possible choices of array, some of which have the same number of symbols as each other (such as two 3 by 5 options) may be provided. The arrays may have any arbitrary number of reels and operative positions. The feature game may use completely different symbols and pay table to the primary game.

The references noted are hereby incorporated by reference. However, the references are merely cited and are the citation is not to be taken as an admission that the matters therein form part of the common general knowledge in the field.

1. A method for operating a gaming machine, including at least the steps of:
(a) Providing a first game to a player, including displaying a set of gaming symbols;
(b) Playing said first game, and if a triggering event occurs, commencing a feature game;
(c) presenting the player with a selection from a set of simulated reel game arrays, each game array in said set having a number of symbol positions, wherein at least two of said game arrays have a different number of symbol positions, and accepting a selection from said player; and
(d) playing said feature game in accordance with the selected reel game array.

2. A method according to claim 1, wherein the game arrays have the form n times m, where n and m are integers corresponding to a number of reels and reel positions.

3. A method according to claim 2, wherein the set includes 3 by 5, 4 by 5 and 5 by 5 game arrays.

4. A gaming machine, including a processing unit, at least one display, and player operable controls for operatively making selections during the operation of the gaming machine, the processing unit being configured and adapted to play a primary game, including causing a set of symbols on said display, and being further adapted to determine whether a triggering event for a feature game has occurred,
Wherein if the triggering event has occurred, commencing play of a feature game, by first presenting the player with a selection from a set of simulated reel game arrays, each game array in said set having a number of symbol positions, wherein at least two of said game arrays have a different number of symbol positions, accepting a selection from said player; and playing said feature game in accordance with the selected reel game array.

5. A gaming machine according to claim 4, wherein the game arrays have the form n times m, where n and m are integers corresponding to a number of reels and reel positions.

6. A method according to claim 5, wherein the set includes 3 by 5, 4 by 5 and 5 by 5 arrays.

7. A software product operatively adapted to carry out the method of claim 1 when made operative on a gaming machine or processor.

8. A storage medium, including a set of instructions operatively adapted to carry out the method of claim 1 when made operative on a gaming machine or processor.
